(19) United States
(12) Patent Application Publication
(10) Pub. No.: US 2005/0082357 A1
(43) Pub. Date: Apr. 21, 2005

(54) Collapsible container

(76) Inventors: Gilroy Clements McAlpine, Benoni (ZA); Alexander John Bronkhorst, 1501 Benoni (ZA); Marius Le Roux, Johannesburg (ZA)

Correspondence Address: OSTROLENK FABER GERB & SOFFEN, 1180 AVENUE OF THE AMERICAS, NEW YORK, NY, 100368403, US

(21) Appl. No.: 10/499,096

(22) PCT Filed: Dec. 18, 2002
(86) PCT No.: PCT/ZA02/00214

(30) Foreign Application Priority Data
Dec. 18, 2001 (ZA) 2001/10345

(51) Int. Cl. B26D 5/42

(52) U.S. Cl. 229/198.1

(57) ABSTRACT

A collapsible container (10) comprising a foldable blank (11), having a base panel (14), a pair of opposed side wall panels (12) and a pair of opposed end wall (13) panels, the side wall panels and the end wall panels being foldable into an upright position relative to the base panel to define adjacent side and end walls with four corners at their junctions; at least one reinforcing, load bearing pillar member (15); and at least one connecting clip (16), the connecting clip and the pillar member being configured and dimensioned to connect with adjacent side and end wall panels at a corner junction in an upright position while providing reinforcement and a top load bearing capability to the container.

### TECHNICAL FIELD

This invention relates to a reinforced collapsible container, and more particularly, to a reinforced collapsible container made from flexible sheet material such as cardboard or extruded plastic.

### BACKGROUND ART

Cardboard and plastic-type collapsible containers, crates or boxes (hereinafter collectively referred to as “containers”), erectable out of foldable container blanks, are well known. These collapsible containers are used extensively for the transporting of a variety of consumer goods such as beverages, canned foodstuffs and fresh produce. The fresh produce may include fruit, vegetables or other perishable items, all of which can easily be damaged or bruised.

In the fresh produce market in general and in the fruit export market in particular, a problem exists in that when too many boxes are stacked on top of one another, the containers tend to crumple and even collapse, loosing presentability and damaging the contents. This is particularly pertinent of the cardboard containers when they are brought into contact with fluids, with the consequental weakening of the cardboard, such as when wet or damp fruit is packed into the boxes, when condensate forms on the fruit due to temperature changes in cold storage and ripening rooms or when produce fluids drain onto the cardboard.

Various improved collapsible containers, providing solutions to the above problem, are known and have been described in previous patents and patent applications, notably by the inclusion of reinforcing corner posts for bearing the vertical or so-called top loadings in column stacked arrangements. Most of the reinforced corner posts fall into two primary design groups. The first design group comprises of extended or additional panels of foldable container blanks, foldable such as to provide the posts of the containers in the erected format. The second design group comprises independent pillar members, locatable in or towards the corner of the container in the erected format, and attachable to the container blanks to provide the corner posts. One known design of the independent pillar members, described in International patent Application no. PCT/ZA99/00020, comprises an inner-and-outer flange arrangement, the flanges being designed to engage with each other through tongue-and-groove formations as well as to improve the bearing of the top load in a column stacked arrangement. The flange arrangement is, however, costly to manufacture and complicated to insert.

### OBJECT OF THE INVENTION

It is accordingly an object of the present invention to provide a novel yet relatively simple and inexpensive reinforced collapsible container that at least partially overcomes the problems mentioned above.

### DISCLOSURE OF THE INVENTION

According to a first aspect of the invention there is provided a collapsible container comprising

a foldable blank, having
a base panel;
a pair of opposed side wall panels and
a pair of opposed end wall panels,
the side wall panels and the end wall panels being foldable into an upright position relative to the base panel so as to define adjacent side and end walls with four corners at their junctions; and

at least one reinforcing, load bearing pillar member; and

at least one connecting clip,

the connecting clip and the pillar member being configured and dimensioned to connect with adjacent side and end walls at a corner junction in an upright position while providing reinforcement and top load bearing capability to the container.

The pillar member may be locatable on the inside, alternatively, on the outside of a corner of the folded blank.

The connecting clip and the pillar member may be integral, the clip being capable of securing at least one wall panel to the pillar member.

Alternatively, the connecting clip and the pillar member may be configured and dimensioned to connect with each other, preferably in a snap-fit fashion, securing at least one wall there between.

The connecting clip and the pillar member may be provided with a tongue in groove mechanism, alternatively, the connecting clip and the pillar member may be provided with an insert and twist mechanism.

At least one wall panel may have at least one aperture along an edge, enabling the connecting clip to secure the corresponding wall panel o the pillar member.

The connecting clip may have at least one male protrusion that snap-fits into a female receiving formation on the pillar member, alternately; the pillar member may have at least one male protrusion that snap fits into a female receiving formation on the connecting clip.

The pillar member may be substantially angular in cross-section, defining two longitudinal transverse planar surfaces, dimensioned and configured to abut a corner junction between two adjacent side and end walls substantially along the junction thereof. Each pillar member is preferably provided with a number of spaced apart, receiving formations, extending along each longitudinal planar surface, for receiving an equal number of connecting clips and connecting a pair of adjacent side and end walls at a corner junction in an upright position, while providing reinforcement and top load bearing means to the container.

The container may include a planar arranged string of connecting clips, interconnected and spaced apart for receipt by the correspondingly spaced receiving formations along a single longitudinal planar surface of the pillar member. Preferably, the container may include an angularly arranged string of connecting clips, interconnected and spaced apart for receipt by the correspondingly spaced receiving formations along the two longitudinal transverse planar surfaces of the pillar member.

Each pillar member may include stacking means configured and dimensioned releasably to engage complementary dimensioned pillar members on a corresponding corner post when two containers according to the invention are column stacked upon one another, the pillar member capable of bearing a top load therewith.

Particularly, the stacking means may be longitudinally extending, opposed head and foot formations, configured and dimensioned to engage other containers, preferably in spigot and socket formation.

In one form of the invention, the stacking means may be an integral spigot located at one end of a corner post and adapted to be received in a socket formed in an opposite end of a corresponding corner post when two containers are stacked upon one another.

In another form of the invention, the spigot may be in the form of an expanding barb adapted to pass through the base of the container and to lock within the socket.

The side walls and end wall panel may be attached to the base panel by any hinging means, such as crease lines, perforations, film hinges or the like.

### SPECIFIC EMBODIMENT OF THE INVENTION

A preferred embodiment of the invention will now be described by way of a non-limiting example and with reference to the accompanying drawings wherein:

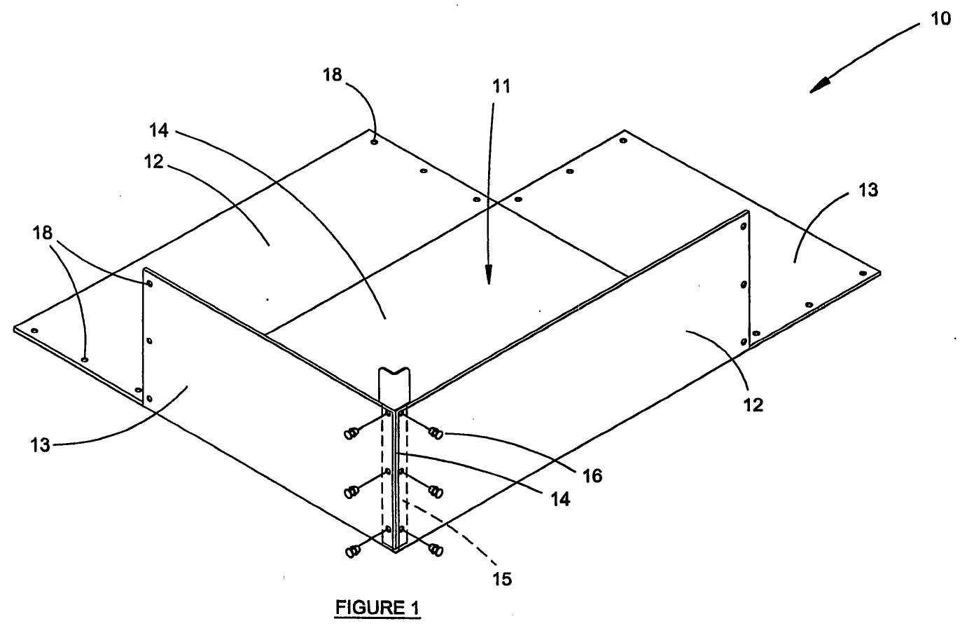

FIG. 1 is a perspective assembly drawing showing the folding of the blank as well as the pillar member located inside the folded blank in accordance with the invention;

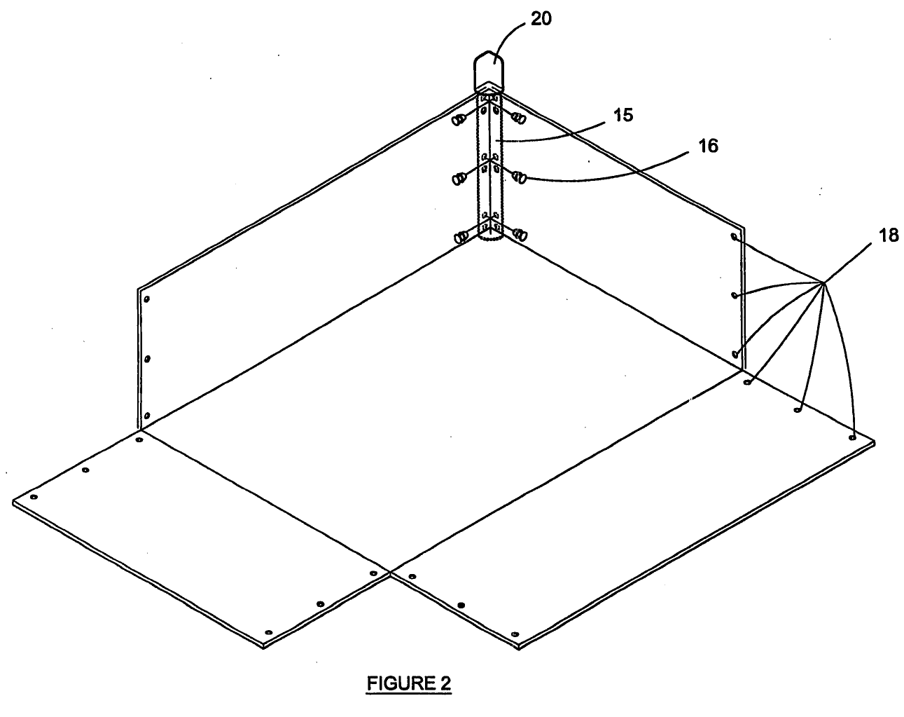

FIG. 2 is a perspective assembly drawing showing the folding of the blank as well as the pillar member located outside the folded blank in accordance with the invention; and

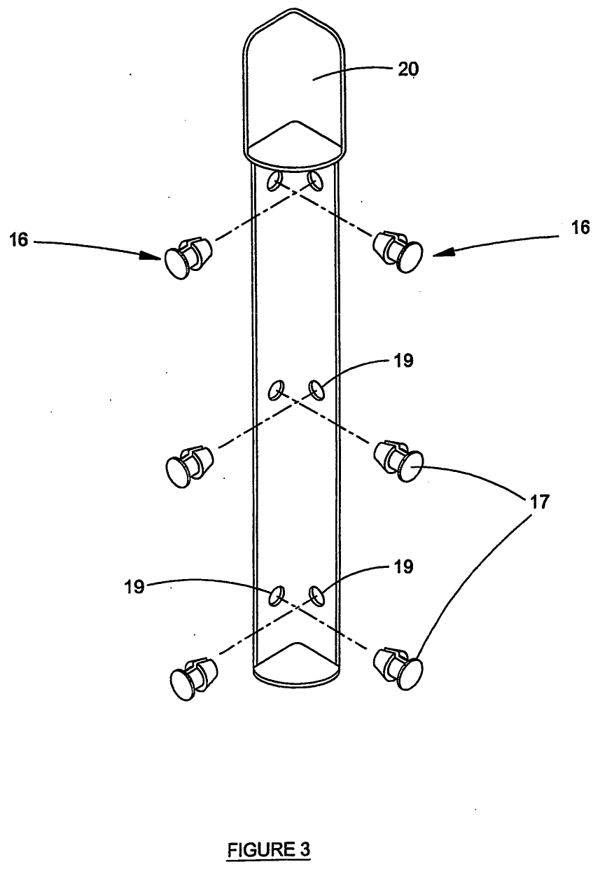

FIG. 3 is a perspective assembly drawing of the inside of the pillar member together with connecting clips in accordance with the invention;

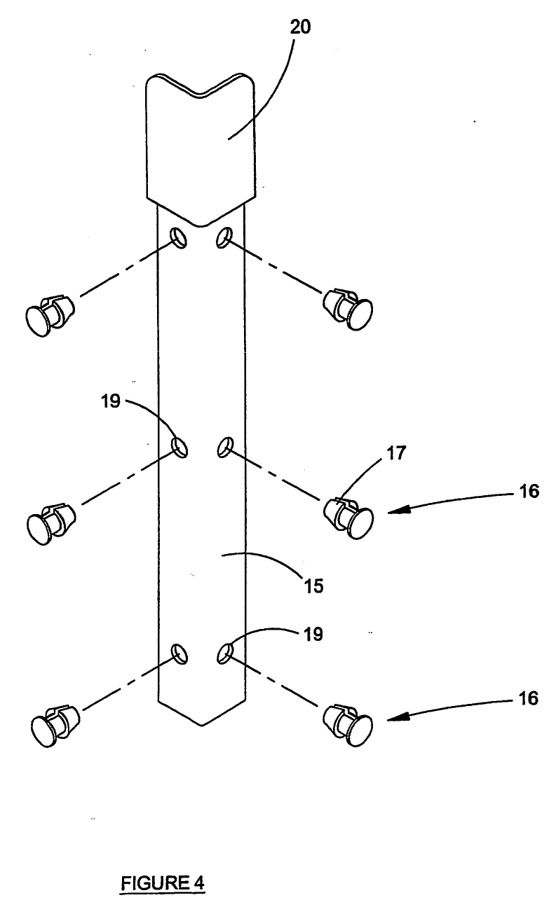

FIG. 4 is a perspective assembly drawing of the outside of the pillar member together with connecting clips in accordance with the invention

The same reference numerals are use to denote corresponding parts in the accompanying drawings.

The reinforced collapsible container (10) comprises a blank (11) that is folded to form side walls (12) and end walls (13) extending upwardly from the base (14). The side walls (12) and the end walls (13) define corners at their junction with adjacent end walls (13) and side walls (12).

At the corners (14), pillar members (15) abut against the side walls (12) and end walls (13). The pillar members (15) may be inserted either on the inside of the folded blank (see FIG. 1), or on the outside of the folded blank (see FIG. 2). The pillar members (15) connect the end walls (13) and side walls (12) to each other, and reinforce the corners of the container (10).

In the embodiment shown by the diagrams, the male formations (17) on the connecting clips (16) protrude through apertures in the side walls (12) and end walls (13) and snap fit into the female formations (19) in the pillar member (15).

In alternative embodiments, the male formations (17) may be on the pillar member (15) and the female formations (19) may be on the connecting clips (16).

The pillar member (15) includes a stacking means (20), which is adapted to engage the bottom of a corresponding corner post (15) of a similar container (10) stacked on top of it.

It will be appreciated that may variations in detail are possible without departing from the scope and spirit of the invention, substantially as claimed in the claims hereinafter.

1. A collapsible container comprising a foldable blank, having a base panel, a pair of opposed side wall panels and a pair of opposed end wall panels, the side wall panels and the end wall panels being foldable into an upright position relative to the base panel to define adjacent side and end walls with four comers at their junctions; at least one reinforcing, load bearing pillar member, and at least one connecting clip, the connecting clip and the pillar member being configured and dimensioned to connect with adjacent side and end wall panels at a corner junction in an upright position while providing reinforcement and a top load bearing capability to the container.

2. A collapsible container as claimed in claim 1 having four pillar members, locatable on the inside of a corner of the folded blank.

3. A collapsible container as claimed in claim 1 having four pillar members locatable on the outside of a corner of the folded blank.

4. A collapsible container as claimed in claim 1 wherein the connecting clip and the pillar member are integral, the clip being capable of securing at least one wall panel to the pillar member.

5. A collapsible container as claimed in claim 1 wherein the connecting clip and the pillar member are distinct parts, configured and dimensioned to connect with each other, securing at least one wall panel there between.

6. A collapsible container as claimed in claim 1 wherein at least one wall panel has at least one aperture along an edge, enabling the connecting clip to secure the corresponding wall panel to the pillar member there through.

7. A collapsible container as claimed in claim 1 wherein the pillar member is substantially angular in cross-section, defining two longitudinal transverse planar surfaces, dimensioned and configured to abut a corner junction between two adjacent side and end walls substantially along the junction thereof.

8. A collapsible container as claimed in claim 7 wherein the pillar member is provided with a number of spaced apart, receiving formations, extending along each longitudinal planar surface, for receiving an equal number of connecting clips and connecting a pair of adjacent side and end wall panels at a corner junction in an upright position, while providing reinforcement and top load bearing capability to the container.

9. A collapsible container as claimed in claim 8 having a planar arranged string of connecting clips, interconnected and spaced apart for receipt by the correspondingly spaced receiving formations along a longitudinal planar surface of the pillar member and connection of a wall panel at a corner junction in an upright position.

10. A collapsible container as claimed in claim 8 having an angularly arranged string of connecting clips, interconnected and spaced apart for receipt by the correspondingly spaced receiving formations along the two longitudinal transverse planar surfaces of the pillar member and connection of a pair of adjacent side and end wall panels at a corner junction in an upright position.

11. A collapsible container as claimed in claim 1 having a pillar member with stacking means configured and dimensioned releasably to engage complementary dimensioned pillar members in a column stacked arrangement, the pillar member capable of bearing a top load therewith.

12. A collapsible container as claimed in claim 11 wherein the stacking means includes longitudinally extending, opposed head and foot formations, configured and dimensioned to engage complementary dimensioned pillar members in a column stacked arrangement, the pillar member capable of bearing a top load therewith.
